(19) United States
(12) Patent Application Publication
(10) Pub. No.: US 2025/0225477 A1
(43) Pub. Date: Jul. 10, 2025

(54) PLANOGRAM DATA GENERATION DEVICE, PLANOGRAM DATA GENERATION METHOD, AND STORAGE MEDIUM

(71) Applicant: NEC Corporation, Minato-ku, Tokyo (JP)

(72) Inventor: Yaeko YONEZAWA, Tokyo (JP)

(73) Assignee: NEC Corporation, Minato-ku, Tokyo (JP)

(21) Appl. No.: 18/853,515

(22) PCT Filed: Sep. 13, 2022
(86) PCT No.: PCT/JP2022/034166

§ 371 Date: Oct. 2, 2024

(51) Int. Cl. G06Q 10/087; G06Q 30/0601; G06V 10/25

(52) U.S. Cl. CPC G06Q 10/087; G06Q 30/0627; G06Q 30/0629; G06V 10/25

(57) ABSTRACT

Provided is a planogram data generation device comprising: an image acquisition unit that acquires a first image that includes a product shelf on which products are displayed; an identification unit that identifies a stockout area of the product shelf that is included in the first image; and a generation unit that determines a second image from among a plurality of the first images on the basis of the stockout area and generating planogram data on the product shelf on the basis of the second image.

### TECHNICAL FIELD

The present invention relates to a planogram data generation device, a planogram data generation system, a planogram data generation method, and a storage medium.

### BACKGROUND ART

Planogram data obtained by converting a place where each product is supposed to be displayed into data in a retail store or the like is one of pieces of information required for store management. Techniques for generating such planogram data include a technique for generating the planogram data by capturing an image of a product shelf on which products are displayed and analyzing the captured image.

For example, PTL 1 discloses a technique of reproducing a planogram by identifying each product displayed in a selling space, from a digital image of a picture of the selling space, and arranging master product data having product information at a relevant position of a fixture model, based on an identification result.

### CITATION LIST

### Patent Literature

PTL 1: JP 2009-187482 A

### SUMMARY OF INVENTION

### Technical Problem

In a case where the planogram data is generated by performing image recognition on an image including a product shelf, it is desirable to generate planogram data by taking into account a stockout portion.

Thus, one object of the present invention is to provide a planogram data generation device, a planogram data generation system, a planogram data generation method, and a storage medium that make it possible to generate planogram data that takes into account a stockout, based on an image that includes a product shelf on which products are displayed.

### Solution to Problem

An aspect of a planogram data generation device according to the present invention includes an image acquisition means for acquiring a first image including a product shelf for displaying products, a specifying means for specifying a stockout region of the product shelf included in the first image, and a generation means for determining a second image from among a plurality of the first images, based on the stockout region, and generating planogram data on the product shelf, based on the second image.

An aspect of a planogram data generation system according to the present invention includes an image acquisition means for acquiring a first image including a product shelf for displaying products, a specifying means for specifying a stockout region of the product shelf included in the first image, and a generation means for determining a second image from among a plurality of the first images, based on the stockout region, and generating planogram data on the product shelf, based on the second image.

An aspect of a planogram data generation method according to the present invention includes acquiring a first image including a product shelf for displaying products, specifying a stockout region of the product shelf included in the first image, and determining a second image from among a plurality of the first images, based on the stockout region, and generating planogram data on the product shelf, based on the second image.

An aspect of a computer-readable storage medium that stores a program according to the present invention causes a computer to execute acquiring a first image including a product shelf for displaying products, specifying a stockout region of the product shelf included in the first image, and determining a second image from among a plurality of the first images, based on the stockout region, and generating planogram data on the product shelf, based on the second image.

### Advantageous Effects of Invention

According to the present invention, the accuracy of planogram data generated through image recognition can be improved.

### BRIEF DESCRIPTION OF DRAWINGS

FIG. 1 is a block diagram illustrating an exemplary configuration of a planogram data generation device according to first and second example embodiments.

FIG. 2 is a flowchart illustrating an exemplary operation of the planogram data generation device according to the first example embodiment.

FIG. 3 is a block diagram illustrating an exemplary configuration of a planogram data generation device according to a third example embodiment.

FIG. 4 is an example of a marketed product database.

FIG. 5 is a flowchart illustrating an exemplary operation of the planogram data generation device according to the third example embodiment.

FIG. 6 is a block diagram illustrating an exemplary configuration of a planogram data generation device according to a fourth example embodiment.

FIG. 7 is a flowchart illustrating an exemplary operation of the planogram data generation device according to the fourth example embodiment.

FIG. 8 is a block diagram depicting a hardware configuration of an information processing device capable of configuring each of the planogram data generation devices according to each example embodiment.

### EXAMPLE EMBODIMENT

### First Example Embodiment

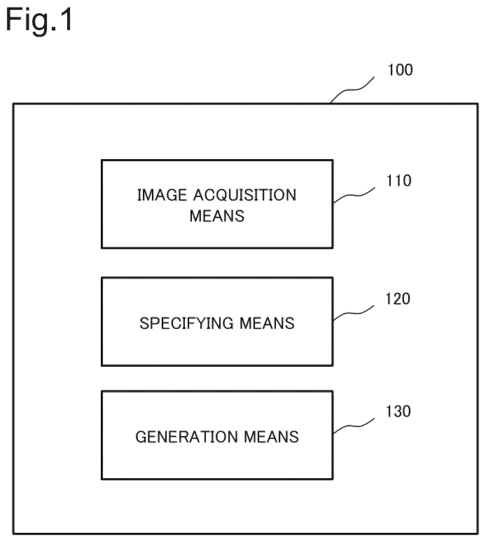

FIG. 1 illustrates a configuration example of a planogram data generation device 100 according to a first example embodiment of the present invention.

The planogram data generation device 100 includes an image acquisition means 110, a specifying means 120, and a generation means 130.

The image acquisition means 110 acquires a first image including a product shelf for which planogram data is to be generated. Products are displayed on the product shelf.

The specifying means 120 specifies a stockout region of the product shelf included in the first image. The stockout region is a region where no product is displayed.

The generation means 130 generates planogram data on the product shelf, based on a second image. Here, the second image is an image determined from among a plurality of the first images, based on the stockout region.

In FIG. 1, each block included in the planogram data generation device 100 indicates a configuration of functional units. Accordingly, each block included in the planogram data generation device 100 illustrated in FIG. 1 may be mounted in a single device, or may be separately mounted in a plurality of devices and configured as a planogram data generation system.

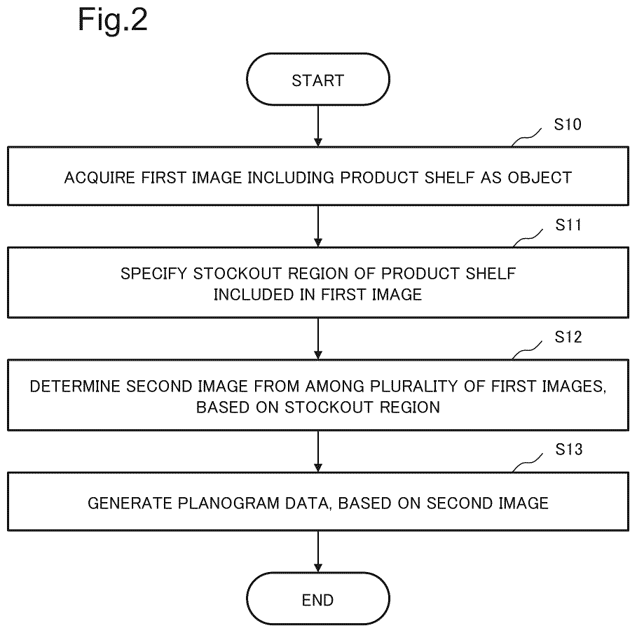

An operation of the planogram data generation device 100 according to the first example embodiment will be described with reference to the drawings. FIG. 2 is a flowchart illustrating a planogram data generation method used by the planogram data generation device 100 according to the first example embodiment. The planogram data generation device 100 operates in accordance with such a flowchart.

The image acquisition means 110 acquires a first image including a product shelf for which planogram data is to be generated (step S10), and the specifying means 120 specifies a stockout region of the product shelf included in the first image (step S11). Then, the second image is determined from among a plurality of the first images, based on the stockout region (step S12). However, the second image may be determined by the specifying means 120 or the generation means 130. The second image may be determined by a determination means (not illustrated). Thereafter, the generation means 130 generates planogram data on the product shelf, based on the second image (step S13), and the planogram data generation device ends the process.

In the planogram data generation device according to the first example embodiment, planogram data on a product shelf is generated from an image determined based on the stockout region. This enables to generate the planogram data taking into account a stockout.

### Second Example Embodiment

In a second example embodiment, the planogram data generation device 100 of the present invention will be described in more detail. Hereinafter, the same configurations and the same operations as those of the first example embodiment will be denoted by the same reference signs, and description of portions whose descriptions overlap will be omitted.

A configuration example of a planogram data generation device 100 according to the second example embodiment of the present invention is similar to that in FIG. 1.

An image acquisition means 110 acquires a first image including a product shelf for which planogram data is to be generated. Examples of the image acquired by the image acquisition means 110 include, but are not limited to, an image captured by a terminal held by a store clerk or a customer of the store, an image captured by a patrol robot in the store, an image captured by a camera in the store, and the like.

For the acquisition of the image by the image acquisition means 110, the image may be directly acquired from a terminal that has captured the image, or may be acquired via a network or the like. In one configuration, an image stored in a storage such as a cloud may be acquired.

The image acquisition means 110 may acquire an image each time an image is captured, or may collectively acquire a plurality of images.

The specifying means 120 processes the first image to specify a region where no product is displayed (stockout region). Furthermore, the specifying means 120 may specify a region where products are displayed (product region). The specifying means 120 may recognize an object in the first image, for example, using an existing image recognition technique, and specify a region where no object has been allowed to be recognized, as a stockout region. At this time, the specifying means 120 only needs to be able to recognize the presence or absence of the object and does not need to recognize which product the recognized object is. For example, the specifying means 120 may store a background of the product shelf and specify a region where the background is not allowed to be recognized, as a product region, and a region where the background is allowed to be recognized, as a stockout region.

The specifying means 120 may specify how many types of products are to be displayed in the specified stockout region. For example, the specifying means 120 may recognize a shelf label in addition to the stockout region. In this case, how many types of products are to be displayed in the specified stockout region can be specified depending on how many shelf labels are given to the stockout region. As an example, in a case where three shelf labels are given to one specified stockout region, it can be specified that three types of products are to be displayed in the specified stockout region.

As another example, the specifying means 120 may specify how many types of products are to be displayed in the specified stockout region, based on a display status in the periphery of the stockout region.

In this case, the specifying means 120 can recognize a peripheral product in the specified stockout region and specify how many types of products are to be displayed in the specified stockout region, based on a display width of the peripheral product. Specifically, in a case where the display width of the peripheral products is fixed, how many types of products are to be displayed in the specified stockout region can be specified by dividing the width of the specified stockout region by the display width of the peripheral products. As an example, a case will be considered in which the specified stockout region has 90 cm, and the display width of the peripheral products is 30 cm that is fixed. In this case, by dividing the width (90 cm) of the specified stockout region by the display width (30 cm) of the peripheral products, it can be specified that three types of products will be displayed in the specified stockout region. In a case where the display width of the peripheral products is not fixed, how many types of products are to be displayed in the specified stockout region can be specified by dividing the width of the specified stockout region by an average value of the display widths of the peripheral products. For example, a case will be considered in which the specified stockout region has 80 cm, and the display widths of the peripheral products are 15 cm, 17 cm, 23 cm, and 25 cm. In this case, by dividing the width (80 cm) of the specified stockout region by the average value (20 cm) of the display widths of the peripheral products, it can be specified that four types of products will be displayed in the specified stockout region.

Besides, the specifying means 120 may specify how many types of products are to be displayed in the specified stockout region, based on the display width of a particular peripheral product. Specifically, how many types of products are to be displayed in the specified stockout region can be specified by dividing the width of the specified stockout region by the display width of the particular peripheral product. Here, the particular peripheral product refers to one peripheral product having a predetermined positional relationship with the specified stockout region. Conceivable examples of the particular peripheral product include, but are not limited to, a product adjacent to the specified stockout region, and a product at an upper shelf or a lower shelf of the specified stockout region.

The generation means 130 generates planogram data on the product shelf, based on the second image. The generation means 130 recognizes a product included in the second image, for example, using an existing image recognition technique, and generates planogram data on the product shelf.

Here, the second image is an image determined from among a plurality of the first images, based on the stockout region. The second image may be determined by the specifying means 120 or the generation means 130. The second image may be determined by a determination means (not illustrated). As a method for determining the second image, for example, an image in which the stockout region is less than a predetermined threshold may be assigned as the second image from among a plurality of the first images. Specifically, it is conceivable to verify that the stockout region is less than a predetermined threshold in case where the area of the stockout region is equal to or less than a predetermined level or in case where the number of pixels of the stockout region is equal to or less than a predetermined level. In addition, it is conceivable to verify that the stockout region is less than a predetermined threshold in case where the number of stockout regions is equal to or less than a predetermined level. The number of types of products to be displayed in the stockout region may be treated as the number of stockout regions. The number of types of products to be displayed in the stockout region can be specified by the above-described methods. Furthermore, in a case where a plurality of images having a stockout region less than a predetermined threshold exist, an image having the latest capturing date and time may be assigned as the second image from among those images.

As another example of the method for determining the second image, an image having the least stockout region may be assigned as the second image from among the plurality of first images. Specifically, it is conceivable that an image having the smallest area of the stockout region is assigned as the second image, and an image having the smallest number of pixels of the stockout region is assigned as the second image from among the plurality of first images. An image having the smallest number of stockout regions may be assigned as the second image from among the plurality of first images. However, these are mere examples, and the method for determining the second image is not limited to these examples.

An operation of the planogram data generation device 100 according to the second example embodiment of the present invention is similar to that in FIG. 2.

In the planogram data generation device according to the second example embodiment, planogram data on a product shelf is generated from an image determined based on the stockout region. This enables to generate the planogram data taking into account a stockout.

By assigning an image in which the stockout region is less than a predetermined threshold as the second image from among a plurality of the first images, planogram data can be generated using an image including a smaller number of stockouts. Therefore, the accuracy of the generated planogram data can be improved. Furthermore, since the stockout region included in the second image is regularly made equal to or less than the predetermined threshold, the accuracy of the generated planogram data can be maintained high.

By assigning an image having the least stockout region as the second image from among a plurality of the first images, planogram data can be generated using an image including a small number of stockouts. Therefore, the accuracy of the generated planogram data can be improved. Furthermore, by using an image having the least stockout region among the first images, planogram data can be generated with the best accuracy.

### Third Example Embodiment

A planogram data generation device 200 according to a third example embodiment is different from the planogram data generation device 100 according to the second embodiment in that the planogram data generation device 200 includes an estimation means 140. Hereinafter, the same configurations and the same operations as those of the second example embodiment will be denoted by the same reference signs, and description of portions whose descriptions overlap will be omitted.

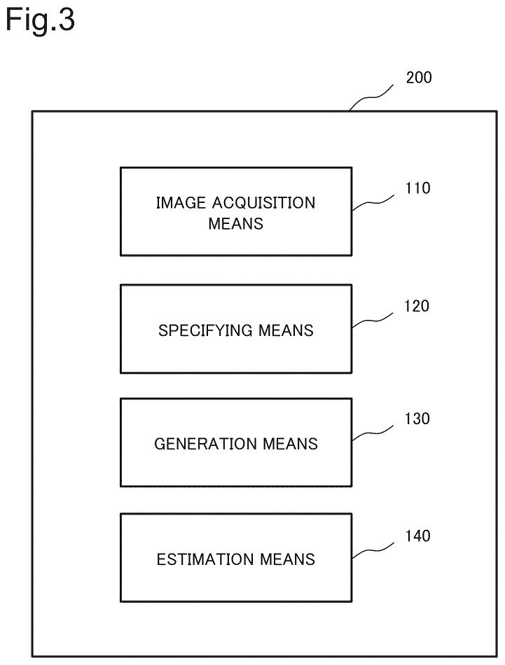

FIG. 3 illustrates a configuration example of the planogram data generation device 200 according to the third example embodiment of the present invention. The planogram data generation device 200 includes an image acquisition means 110, a specifying means 120, a generation means 130, and the estimation means 140.

The estimation means 140 specifies a stockout product candidate by comparing the displayed product included in the second image with a marketed product that is a product marketed in the store. Specifically, the displayed products are compared with the marketed products, and a product included in the marketed products but not included in the displayed products is specified as a stockout product candidate.

The displayed product is a product displayed on the product shelf included in the second image. The displayed product is recognized using, for example, an existing image recognition technique. The displayed product may be recognized by the specifying means 120 or the estimation means 140. The recognition of the displayed product may be executed by a recognition means (not illustrated).

The marketed product is a product marketed in the store.

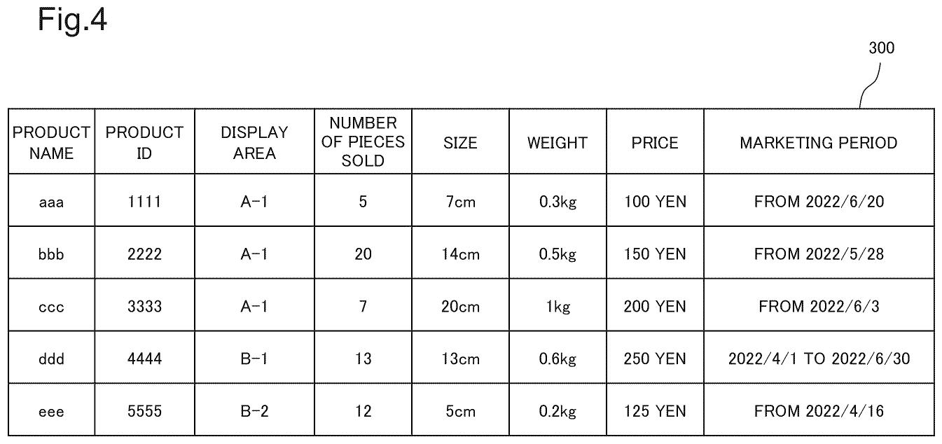

Information on the marketed product is stored in a storage means (not illustrated) as a marketed product database. FIG. 4 illustrates an example of a marketed product database 300. The marketed product database 300 includes a product name, a product identification (ID), a display area, the number of pieces sold, a size, a weight, a price, and a marketing period. The information included in the marketed product database 300 illustrated in FIG. 4 is a mere example and is not limited thereto. For example, the marketed product database 300 may further store a category of the product.

The product name represents a name of each product. The product ID represents identification information that is identifiably allocated to each product. The product ID is represented by any character string or numerical sequence, a combination of characters and numbers, or the like.

The display area indicates an area in which each product is displayed. The display area may be represented by a product shelf ID indicating a product shelf on which the product is displayed. The display area may be represented by designation indicating a sales area for each product category, such as “beverage area” or “confectionery area”.

The number of pieces sold indicates the number of pieces sold of each product. The number of pieces sold stored in the marketed product database may be the number of pieces sold on the concerned day or the cumulative number of pieces sold during a predetermined period.

The size indicates the size of each product. The size includes at least one of a width, a height, and a depth of the product. The area of the front of the product when displayed may be stored as the size. Besides, the volume of the product may be stored as the size.

The weight indicates the weight of each product. The price indicates a sales price of each product.

The marketing period indicates a marketing period of each product in the store. For the marketing period, either a marketing start time point or a marketing end time point may be stored, or the term from the marketing start time point to the marketing end time point may be stored.

The estimation means 140 may compare with all the marketed products included in the marketed product database 300, or may compare with some of the marketed products in the marketed product database 300. For example, among the products included in the marketed product database 300, a product whose display area coincides with an area included in the second image may be compared with the displayed product included in the second image. Specifically, the displayed products included in the second image may be compared with the marketed products whose display areas coincide with an area included in the second image, and a product included in the marketed products but not included in the displayed products may be specified as a stockout product candidate.

The estimation means 140 may compare a product in the same category as the category of the product included in the second image, among the products included in the marketed product database 300, with the displayed product included in the second image. Specifically, the displayed products included in the second image may be compared with the marketed products in the same categories as the categories of the displayed products included in the second image, and a product included in the marketed products but not included in the displayed products may be specified as a stockout product candidate.

The estimation means 140 may compare a product whose marketing period includes the time point of comparison, among the products included in the marketed product database 300, with the displayed product included in the second image. Specifically, the displayed products included in the second image may be compared with the marketed products whose marketing periods include the time point of comparison, and a product included in the marketed products but not included in the displayed products may be specified as a stockout product candidate. Besides, the estimation means 140 may compare a product having a price matching the price range of the products displayed in an area included in the second image, among the products included in the marketed product database 300, with the displayed product included in the second image. Specifically, the displayed products included in the second image may be compared with the marketed products having prices matching the price range of the products displayed in an area included in the second image, and a product included in the marketed products but not included in the displayed products may be specified as a stockout product candidate.

Then, the estimation means 140 estimates a stockout product whose display place is to be assigned as the stockout region, from among the stockout product candidates. For example, in a case where one stockout product candidates has been found, the one stockout product candidate is estimated as the stockout product. In a case where the number of the stockout regions matches the number of the stockout product candidates, the stockout product candidates may be estimated as the stockout products. Furthermore, in a case where a plurality of stockout product candidates has been found, the stockout product may be estimated by a method to be described later.

In a case where the stockout product candidate has not been allowed to be specified, the stockout region is highly likely to be a part of the display place of a product displayed adjacent to the stockout region. Thus, in a case where the stockout product candidate has not been allowed to be specified, the estimation means 140 may estimate a product displayed adjacent to the stockout region, as a stockout product whose display place is to be assigned as that stockout region. Alternatively, a product displayed in an upper shelf or a lower shelf of the stockout region may be estimated as a stockout product whose display place is to be assigned as that stockout region. Specifically, in a case where the displayed products are compared with the marketed products and no product has been found as a product included in the marketed products but not included in the displayed products, a product displayed adjacent to the stockout region may be estimated as a stockout product whose display place is to be assigned as that stockout region.

The generation means 130 generates planogram data on the product shelf, based on the second image and the stockout product estimated by the estimation means 140.

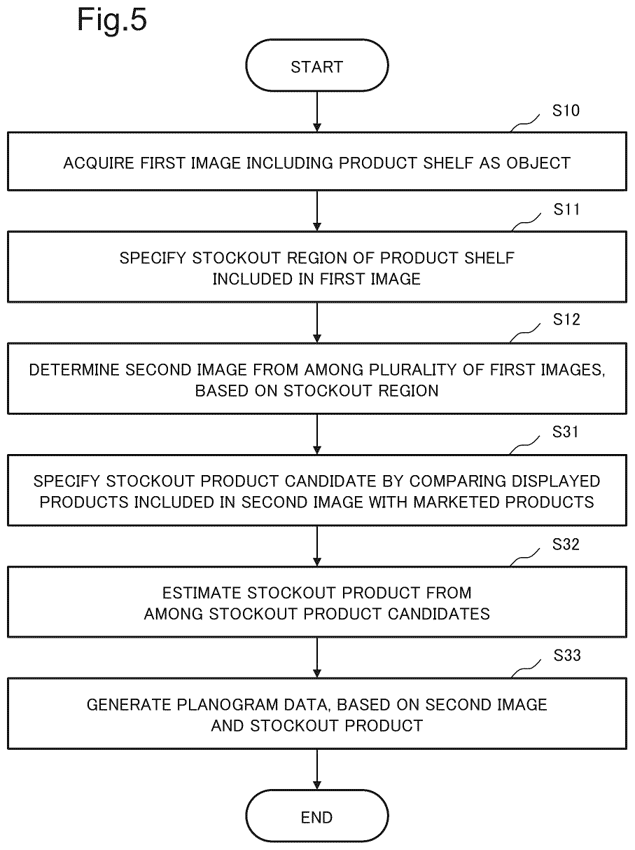

An operation of the planogram data generation device according to the third example embodiment will be described with reference to the drawings. FIG. 5 is a flowchart illustrating an exemplary operation of the planogram data generation device according to the third example embodiment.

Since steps S10 to S12 are similar to those in FIG. 2, description thereof will be omitted. The estimation means 140 specifies a stockout product candidate by comparing the displayed products included in the second image with the marketed products (step S31). Then, a stockout product whose display place is to be assigned as the stockout region is estimated from among the stockout product candidates (step S32). Thereafter, the generation means 130 generates planogram data on the product shelf, based on the second image and the stockout product estimated by the estimation means 140 (step S33).

In the planogram data generation device according to the third example embodiment, planogram data on a product shelf is generated from an image determined based on the stockout region. This enables to generate the planogram data taking into account a stockout.

A stockout product is estimated, and planogram data on the product shelf is generated based on the image and the estimated stockout product. This enables to also generate the planogram data on the stockout region, and thus, the planogram data can be generated by taking into account a stockout. Even in a case where a stockout region exists, the planogram data can be accurately generated.

### Fourth Example Embodiment

A planogram data generation device 400 according to a fourth example embodiment is different from the planogram data generation device 200 according to the third embodiment in that the planogram data generation device 400 includes a product information acquisition means 150. Hereinafter, the same configurations and the same operations as those of the third example embodiment will be denoted by the same reference signs, and description of portions whose descriptions overlap will be omitted.

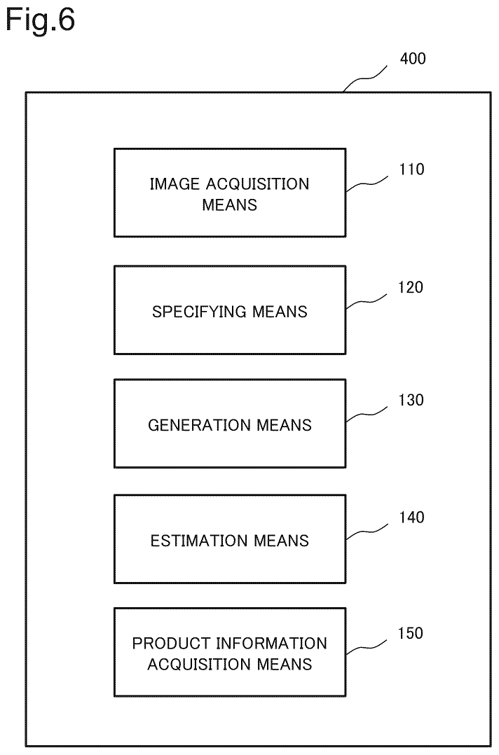

FIG. 6 illustrates a configuration example of the planogram data generation device 400 according to the fourth example embodiment of the present invention. The planogram data generation device 400 includes an image acquisition means 110, a specifying means 120, a generation means 130, an estimation means 140, and the product information acquisition means 150.

The estimation means 140 specifies a stockout product candidate by comparing the displayed product included in the second image with a marketed product that is a product marketed in the store. The stockout product candidate may be specified by the methods described in the third example embodiment. Furthermore, a product displayed adjacent to the stockout region may be added to the stockout product candidates. A product displayed in an upper shelf or a lower shelf of the stockout region may also be added to the stockout product candidates. Then, the product information acquisition means 150 acquires product information including at least one of the number of pieces sold, size, weight, and price of the stockout product candidate. For example, the product information acquisition means 150 acquires the product information from a marketed product database 300. The product information may be acquired from a point of sales (POS) terminal or a store computer.

Based on the product information acquired by the product information acquisition means 150, the estimation means 140 estimates a stockout product whose display place is to be assigned as the stockout region, from among the stockout product candidates.

A specific example of the estimation of the stockout product by the estimation means 140 will be described.

### Specific Example 1 of Stockout Product Estimation

The product information acquisition means 150 acquires the number of pieces sold of a stockout product candidate as the product information. The product information acquisition means 150 may further acquire the number of pieces sold of all the marketed products, or acquire the number of pieces sold of some of the marketed products. When the number of pieces sold is large, the product is accordingly likely to be taken out from the product shelf, and thus, a stockout is more likely to have arisen. Therefore, the estimation means 140 estimates a stockout product candidate with a large number of pieces sold, as a stockout product.

As an example, a case will be considered in which one stockout region has been found and two stockout product candidates (a stockout product candidate A1 and a stockout product candidate B1) have been found. In the above, it is assumed that one type of product is to be displayed in this stockout region. It is also assumed that the number of pieces sold of each of the stockout product candidates acquired by the product information acquisition means 150 is as follows.

Stockout Product Candidate A1: 15 pieces
Stockout Product Candidate B1: 7 pieces

At this time, the estimation means 140 estimates the stockout product candidate A1 as a stockout product.

In a case where one stockout region has been found and three or more stockout product candidates have been found, the estimation means 140 estimates a stockout product candidate having the largest number of pieces sold, as a stockout product. Furthermore, in a case where a plurality of stockout regions has occurred, stockout products may be estimated in descending order of the number of pieces sold.

### Specific Example 2 of Stockout Product Estimation

A specific example of a case where two or more stockout regions have occurred will be described. In this case, the estimation means 140 estimates the stockout product, based on a positional relationship between the stockout regions.

As an example, a case where the product information acquisition means 150 acquires the weight of the stockout product candidate as the product information will be described. The product information acquisition means 150 may further acquire weights of all the marketed products, or acquire weights of some of the marketed products. A product having a larger weight is more likely to be placed on a lower side shelf of the product shelf. Therefore, the estimation means 140 estimates the stockout product, based on a positional relationship between the stockout regions and the weight of the stockout product candidate.

As a more specific example, a case will be considered in which two stockout regions (a stockout region X1 and a stockout region Y1) have been found and two stockout product candidates (a stockout product candidate A2 and a stockout product candidate B2) have been found. In the above, it is assumed that one type of product is displayed in each of the stockout regions. It is assumed that the stockout region X1 is located in an upper shelf than the stockout region Y1. It is also assumed that the weight of each of the stockout product candidates acquired by the product information acquisition means 150 is as follows.

### Stockout Product Candidate A2: 1 kg

### Stockout Product Candidate B2: 0.5 kg

At this time, the estimation means 140 estimates the stockout product whose display place is to be assigned as the stockout region Y1,as the stockout product candidate A2, and estimates the stockout product whose display place is to be assigned as the stockout region X1, as the stockout product candidate B2.

The estimation means 140 may estimate the stockout products in such a way that a stockout product candidate having a larger weight is associated with a stockout region closer to a lower shelf of the product shelf in descending order of the weights.

As another example, a case where the product information acquisition means 150 acquires the number of pieces sold of the stockout product candidate as the product information will be described. The product information acquisition means 150 may further acquire the number of pieces sold of all the marketed products, or acquire the number of pieces sold of some of the marketed products. The number of pieces sold changes in some cases depending on the display position of the product. As an example, a product displayed at a height at which a customer can easily take the product by hand sometimes gives a large number of pieces sold. Therefore, the estimation means 140 estimates the stockout product, based on a positional relationship between the stockout regions and the number of pieces sold of the stockout product candidate.

As a more specific example, a case will be considered in which two stockout regions (a stockout region X2 and a stockout region Y2) have been found and two stockout product candidates (a stockout product candidate A3 and a stockout product candidate B3) have been found. In the above, it is assumed that one type of product is displayed in each of the stockout regions. The stockout region X2 is a region that gives a large number of pieces sold. The region that gives a large number of pieces sold may be preset. It is also assumed that the number of pieces sold of each of the stockout product candidates acquired by the product information acquisition means 150 is as follows.

Stockout Product Candidate A3: 15 pieces
Stockout Product Candidate B3: 7 pieces

At this time, the estimation means 140 estimates the stockout product whose display place is to be assigned as the stockout region X2,as the stockout product candidate A3, and estimates the stockout product whose display place is to be assigned as the stockout region Y2, as the stockout product candidate B3.

### Specific Example 3 of Stockout Product Estimation

A specific example will be described of a case where the estimation means 140 estimates a stockout product based on the extent of the stockout region.

As an example, a case where the product information acquisition means 150 acquires the size of the stockout product candidate as the product information will be described. The product information acquisition means 150 may further acquire sizes of all the marketed products, or acquire sizes of some of the marketed products. A product having a large size is not allowed to be displayed in a narrow stockout region. Therefore, the estimation means 140 estimates the stockout product, based on the extent of the stockout region and the size of the stockout product candidate.

As a more specific example, a case will be considered in which one stockout region has been found and two stockout product candidates (a stockout product candidate A4 and a stockout product candidate B4) have been found. In the above, it is assumed that one type of product is displayed in this stockout region and this stockout region has 10 cm as the extent. It is also assumed that the size of each of the stockout product candidates acquired by the product information acquisition means 150 is as follows.

### Stockout Product Candidate A4: 15 cm

### Stockout Product Candidate B4: 5 cm

At this time, the estimation means 140 estimates the stockout product candidate B4 as a stockout product.

In a case where a plurality of stockout regions has occurred, the estimation means 140 may estimate the stockout products in such a way that a stockout product candidate having a larger size is associated with a stockout region having a larger extent in descending order of the sizes.

As another example, a case where the product information acquisition means 150 acquires the number of pieces sold of the stockout product candidate as the product information will be described. The product information acquisition means 150 may further acquire the number of pieces sold of all the marketed products, or acquire the number of pieces sold of some of the marketed products. The extent of a region for use in display changes in some cases depending on the number of pieces sold of the product. As an example, products that sell well are sometimes displayed in a region having a large extent. Therefore, the estimation means 140 estimates the stockout product, based on the extent of the stockout region and the number of pieces sold of the stockout product candidate.

As a more specific example, a case will be considered in which two stockout regions (a stockout region X3 and a stockout region Y3) have been found and two stockout product candidates (a stockout product candidate A5 and a stockout product candidate B5) have been found. In the above, it is assumed that one type of product is displayed in each of the stockout regions. It is assumed that the stockout region X3 is a stockout region having a larger extent than the stockout region Y3. It is also assumed that the number of pieces sold of each of the stockout product candidates acquired by the product information acquisition means 150 is as follows.

Stockout Product Candidate A5: 15 pieces
Stockout Product Candidate B5: 7 pieces

At this time, the estimation means 140 estimates the stockout product whose display place is to be assigned as the stockout region X3,as the stockout product candidate A5, and estimates the stockout product whose display place is to be assigned as the stockout region Y3, as the stockout product candidate B5.

While the specific examples of the estimation of the stockout product by the estimation means 140 have been described above, the specific examples 1 to 3 are mere examples, and these examples are not restrictive. The above-described specific examples may be combined.

An example of combining the above-described specific examples will be described. For example, a case will be considered in which N stockout regions have occurred and M stockout product candidates have occurred. Here, N and M represent natural numbers, where N is a number smaller than M. First, the estimation means 140 specifies N stockout product candidates in descending order of the number of pieces sold, based on the number of pieces sold of each stockout product candidate acquired by the product information acquisition means 150. Then, a stockout product is estimated from the N stockout product candidates, based on a positional relationships between the stockout regions and/or the capacities of the stockout regions. In this manner, by combining the above-described specific examples, stockout products whose display places are each to be assigned as one of the stockout regions can be accurately estimated.

Another example of combining the above-described specific examples will be described. First, the estimation means 140 specifies a stockout product candidate having a size equal to or less than the extent of the stockout region, based on the size of each stockout product candidate acquired by the product information acquisition means 150. Then, based on the number of pieces sold of the stockout product candidates and/or a positional relationship between the stockout regions, the stockout product is estimated from among the stockout product candidates having sizes equal to or less than the extent of the stockout region. Even in a case of this example, stockout products whose display places are each to be assigned as one of the stockout regions can be accurately estimated.

The product information acquired by the product information acquisition means 150 may be product information on all the marketed products, or may be product information on some of the marketed products. For example, the product information on a marketed product whose display area coincides with an area included in the second image may be acquired, or the product information on a marketed product in the same category as the category of the product included in the second image may be acquired. The product information on a marketed product whose marketing period includes the time point of estimation of the stockout product may be acquired. The product information on a marketed product having a price matching the price range of the product displayed in an area included in the second image may be acquired. In a case where the product information on some of the marketed products is acquired in this manner, processing can be reduced as compared with a case of acquiring the product information on all the marketed products.

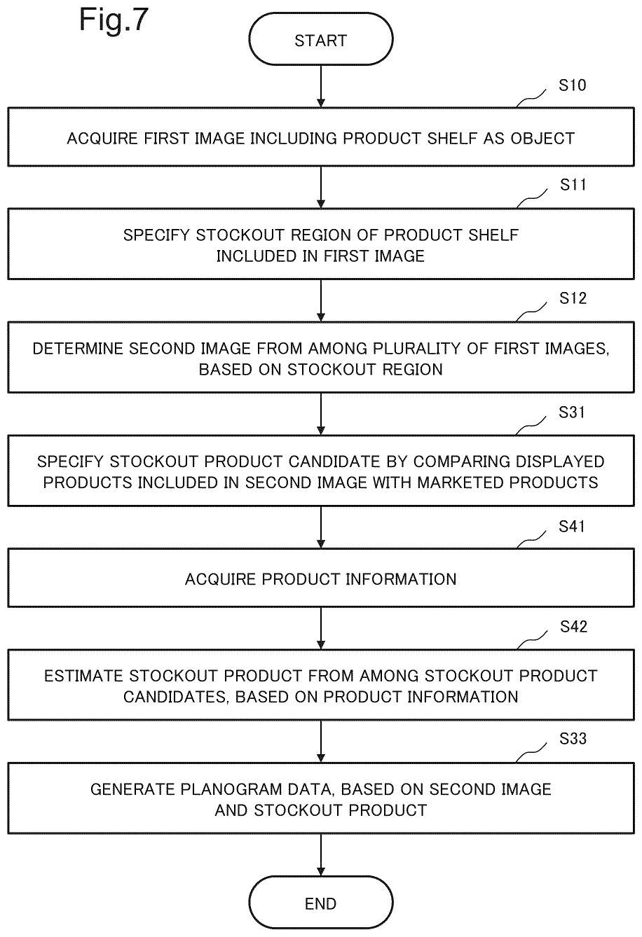

An operation of the planogram data generation device according to the fourth example embodiment will be described with reference to the drawings. FIG. 7 is a flowchart illustrating an exemplary operation of the planogram data generation device according to the fourth example embodiment.

Since steps S10 to S12 are similar to those in FIG. 2 and steps S31 and S33 are similar to those in FIG. 5, description thereof will be omitted. After step S31, the product information acquisition means 150 acquires the product information on the stockout product candidate (step S41). Then, based on the product information, a stockout product whose display place is to be assigned as the stockout region is estimated from among the stockout product candidates (step S42). Thereafter, the process proceeds to step S33.

In the planogram data generation device according to the fourth example embodiment, planogram data on a product shelf is generated from an image determined based on the stockout region. This enables to generate the planogram data taking into account a stockout.

A stockout product is estimated, and planogram data on the product shelf is generated based on the image and the estimated stockout product. This enables to also generate the planogram data on the stockout region, and thus, the planogram data can be generated by taking into account a stockout. Even in a case where a stockout region has occurred, the planogram data can be accurately generated.

Furthermore, the product information including at least one of the number of pieces sold, size, weight, and price of the stockout product candidate is acquired, and the stockout product is estimated based on the product information. This enables to generate the planogram data taking into account a stockout. The accuracy of the product estimation for the stockout region is improved, and the planogram data can be accurately generated.

Among the stockout product candidates, a product with the largest number of pieces sold is estimated as the stockout product. This enables to generate the planogram data taking into account a stockout. The accuracy of the product estimation for the stockout region is improved, and the planogram data can be accurately generated.

In a case where a plurality of stockout regions has occurred, the stockout product is estimated based on a positional relationship between the stockout regions. This enables to generate the planogram data taking into account a stockout. Even in a case where a plurality of stockout regions has been found, the accuracy of product estimation for the stockout regions is improved, and the planogram data can be accurately generated.

Among the stockout product candidates, the product having the largest weight is estimated as the stockout product for a stockout region closest to a lower shelf of the product shelf. This enables to generate the planogram data taking into account a stockout. The accuracy of the product estimation for the stockout region is improved, and the planogram data can be accurately generated.

The stockout product is estimated based on the extent of the stockout region. This enables to generate the planogram data taking into account a stockout. Even in a case where a plurality of stockout regions has been found, the accuracy of product estimation for the stockout regions is improved, and the planogram data can be accurately generated.

A product whose size is equal to or less than the extent of the stockout region is estimated as the stockout product. This enables to generate the planogram data taking into account a stockout. The accuracy of the product estimation for the stockout region is improved, and the planogram data can be accurately generated.

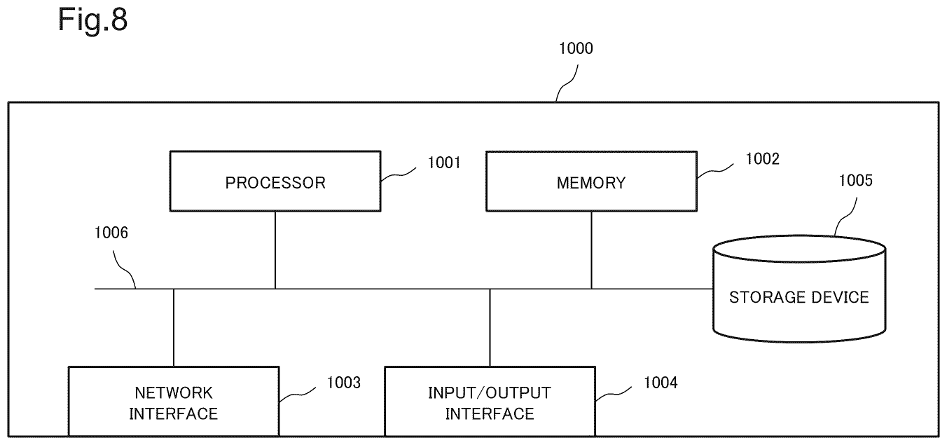

In each example embodiment of the present disclosure, each planogram data generation device is implemented by a combination of hardware and a program. FIG. 8 is a block diagram depicting a hardware configuration of an information processing device 1000 capable of configuring each of the planogram data generation devices according to each example embodiment.

The information processing device 1000 includes a processor 1001, a memory 1002, a network interface 1003, an input/output interface 1004, and a storage device 1005, and the components of the information processing device 1000 are connected to each other by a bus 1006 in such a way that communication is enabled.

The processor 1001 is implemented by a central processing unit (CPU), a graphics processing unit (GPU), or the like.

The memory 1002 is a main storage device implemented by a random access memory (RAM) or the like.

The network interface 1003 is an interface for connecting to a network. Here, the network represents a local area network (LAN) or a wide area network (WAN).

The input/output interface 1004 is an interface for connecting to various kinds of input/output equipment.

The storage device 1005 is an auxiliary storage device implemented by a hard disk drive (HDD), a solid state drive (SSD), a memory card, a read only memory (ROM), or the like. The storage device 1005 may store a program for implementing the function of each of the planogram data generation devices according to each example embodiment.

The processor 1001 reads a program stored in the storage device 1005 into the memory 1002 to execute the read program, thereby implementing the function of each planogram data generation device. The program may be supplied from a network via the network interface 1003. Besides, the program may be stored in advance in a storage medium (not illustrated) and supplied by reading the program.

This program can display processing results of the program, including intermediate states as necessary, for each stage via a display device or can communicate with the outside via the network interface 1003. This program can be recorded on a computer-readable (non-transitory) recording medium.

While the disclosure has been particularly shown and described with reference to exemplary embodiments thereof, the present disclosure is not limited to each of the above-described example embodiments, and a variety of changes may be made therein. An example embodiment obtained by appropriately combining configurations, operations, and processes disclosed in different example embodiments is also included in the technical scope of the present disclosure.

The present disclosure is not limited to the above-described example embodiments. That is, it will be understood by those of ordinary skill in the art that the present invention may apply various aspects without departing from the spirit and scope of the present invention as defined by the claims.

### [Supplementary Note 1]

A planogram data generation device including:
an image acquisition means for acquiring a first image including a product shelf for displaying products;
a specifying means for specifying a stockout region of the product shelf that is included in the first image; and
a generation means for determining a second image from among a plurality of the first images, based on the stockout region, and generating planogram data on the product shelf, based on the second image.

### [Supplementary Note 2]

The planogram data generation device according to supplementary note 1, in which
the second image is an image including the stockout region less than a threshold, among the plurality of the first images.

### [Supplementary Note 3]

The planogram data generation device according to supplementary note 1, in which
the second image is an image including a least stockout region, among the plurality of the first images.

### [Supplementary Note 4]

The planogram data generation device according to supplementary note 2 or 3, further including
an estimation means for specifying a stockout product candidate by comparing a displayed product included in the second image with marketed products being the products marketed in a store in a case where the stockout region in which none of the products are displayed are in the product shelf included in the second image, and estimating a stockout product in which the stockout region is display place is to be assigned as the stockout region, from among the stockout product candidates, in which
the generation means generates the planogram data on the product shelf, based on the second image and the estimated stockout product.

### [Supplementary Note 5]

The planogram data generation device according to supplementary note 4, further including
a product information acquisition means for acquiring product information including at least one of a number of pieces sold, a size, a weight, and a price of the stockout product candidate, in which
the estimation means estimates the stockout product, further based on the product information.

### [Supplementary Note 6]

The planogram data generation device according to supplementary note 5, in which
the product information acquisition means acquires the number of pieces sold, as the product information, and
the estimation means estimates each of the products having a largest number of pieces sold, among the stockout product candidates, as the stockout product.

### [Supplementary Note 7]

The planogram data generation device according to supplementary note 5 or 6, in which
when a plurality of the stockout regions has occurred in the product shelf included in the second image,
the estimation means estimates the stockout product, further based on a positional relationship between the stockout regions.

### [Supplementary Note 8]

The planogram data generation device according to any one of supplementary notes 5 to 7, in which
the product information acquisition means acquires the weight as the product information, and
the estimation means estimates each of the products having a largest weight, among the stockout product candidates, as the stockout product for the stockout region closest to a lower shelf of the product shelf.

### [Supplementary Note 9]

The planogram data generation device according to any one of supplementary notes 5 to 8, in which
the estimation means estimates the stockout product, further based on a extent of the stockout region.

### [Supplementary Note 10]

The planogram data generation device according to any one of supplementary notes 5 to 9, in which
the product information acquisition means acquires the size, as the product information, and
the estimation means estimates each of the products of which the size is equal to or less than a extent of the stockout region, as the stockout product.

### [Supplementary Note 11]

A planogram data generation system including:
an image acquisition means for acquiring a first image that includes a product shelf on which products are displayed;
a specifying means for specifying a stockout region of the product shelf that is included in the first image; and
a generation means for determining a second image from among a plurality of the first images, based on the stockout region, and generating planogram data on the product shelf, based on the second image.

### [Supplementary Note 12]

A planogram data generation method including:
acquiring a first image that includes a product shelf on which products are displayed;
specifying a stockout region of the product shelf that is included in the first image; and
determining a second image from among a plurality of the first images, based on the stockout region, and generating planogram data on the product shelf, based on the second image.

### [Supplementary Note 13]

A computer-readable storage medium that stores a program for causing a computer to execute:
acquiring a first image that includes a product shelf on which products are displayed;
specifying a stockout region of the product shelf that is included in the first image; and
determining a second image from among a plurality of the first images, based on the stockout region, and generating planogram data on the product shelf, based on the second image.

### REFERENCE SIGNS LIST

100, 200, 400 planogram data generation device

110 image acquisition means

120 specifying means

130 generation means

140 estimation means

150 product information acquisition means

300 marketed product database

1000 information processing device

1001 processor

1002 memory

1003 network interface

1004 input/output interface

1005 storage device

1006 bus

What is claimed is:

1. A planogram data generation device comprising:
a memory; and
at least one processor coupled to the memory
the at least one processor performing operations to:
acquire a first image including a product shelf for displaying products;
a stockout region of the product shelf included in the first image; and
determine a second image from among a plurality of the first images based on the stockout region, and generating planogram data on the product shelf based on the second image.

2. The planogram data generation device according to claim 1, wherein the second image is an image including the stockout region less than a threshold, among the plurality of the first images.

3. The planogram data generation device according to claim 1, wherein the second image is an image including the least stockout region, among the plurality of the first images.

4. The planogram data generation device according to claim 2, wherein the at least one processor further performs operation to:
specify a stockout product candidate by comparing a displayed product included in the second image with marketed products being the products marketed in a store in a case where the stockout region, in which none of the products are displayed, are in the product shelf included in the second image, and estimating a stockout product in which the stockout region is display place from among the stockout product candidates, and
generate the planogram data on the product shelf, based on the second image and the estimated stockout product.

5. The planogram data generation device according to claim 4, wherein the at least one processor further performs operation to:
acquire product information including at least one of a number of pieces sold, a size, a weight, and a price of the stockout product candidate, and
estimate the stockout product, further based on the product information.

6. The planogram data generation device according to claim 5, wherein the at least one processor further performs operation to:
acquire the number of pieces sold, as the product information, and
estimate each of the products having the largest number of pieces sold, among the stockout product candidates, as the stockout product.

7. The planogram data generation device according to claim 5, wherein the at least one processor further performs operation to:
in a case where a plurality of the stockout regions are in the product shelf included in the second image,
estimate the stockout product, further based on a positional relationship between the stockout regions.

8. The planogram data generation device according to claim 5, wherein the at least one processor further performs operation to:
acquire the weight as the product information, and
estimate each of the products having the largest weight, among the stockout product candidates, as the stockout product for the stockout region closest to a lower shelf of the product shelf.

9. The planogram data generation device according to claim 5, wherein the at least one processor further performs operation to:
estimate the stockout product, further based on a extent of the stockout region.

10. The planogram data generation device according to claim 5, wherein the at least one processor further performs operation to:
acquire the size, as the product information, and
estimate each of the products of which the size is equal to or less than an extent of the stockout region, as the stockout product.

11. (canceled)

12. A planogram data generation method comprising:
acquiring a first image including a product shelf for displaying products;
specifying a stockout region of the product shelf included in the first image; and
determining a second image from among a plurality of the first images, based on the stockout region, and generating planogram data on the product shelf, based on the second image.

13. A non-transitory computer-readable storage medium that stores a program for causing a computer to execute:
acquiring a first image including a product shelf for displaying products;
specifying a stockout region of the product shelf included in the first image; and
determining a second image from among a plurality of the first images, based on the stockout region, and generating planogram data on the product shelf, based on the second image.
